(19) United States
(12) Patent Application Publication
(10) Pub. No.: US 2024/0021998 A1
(43) Pub. Date: Jan. 18, 2024

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Zedong WANG, Dongguan (CN)

(21) Appl. No.: 18/476,118

(22) Filed: Sep. 27, 2023

Related U.S. Application Data
(63) Continuation of application No. PCT/CN2022/077946, filed on Feb. 25, 2022.

(30) Foreign Application Priority Data
Mar. 30, 2021 (CN) 202110343970.1

(51) Int. Cl. H01Q 9/04; H01Q 1/24; H01Q 5/371

(52) U.S. Cl. CPC H01Q 9/0442; H01Q 1/243; H01Q 5/371

(57) ABSTRACT

An antenna assembly and an electronic device are provided. A first antenna element includes a first radiator, a ground branch, and a first signal source. A joint of a first radiating branch and a second radiating branch is a first feed point. The first signal source is electrically connected to the first feed point. The ground branch, the first signal source, and the first radiating branch form a first sub-antenna. The ground branch, the first signal source, and the second radiating branch form a second sub-antenna. The first sub-antenna is configured to transmit/receive electromagnetic wave signals of a first target band under excitation of the first signal source. The second sub-antenna is configured to transmit/receive electromagnetic wave signals of a second target band under excitation of the first signal source. The first target band at least partially overlaps with the second target band.

### CROSS-REFERENCE TO RELATED APPLICATION(S)

This application is a continuation of International Application No. PCT/CN2022/077946, filed Feb. 25, 2022, which claims priority to Chinese Patent Application No. 202110343970.1, filed Mar. 30, 2021, the entire disclosures of which are incorporated herein by reference.

### TECHNICAL FIELD

This disclosure relates to the field of communication technology, and specifically to an antenna assembly and an electronic device.

### BACKGROUND

With more and more functions of electronic devices, the number and types of electronic components in the electronic device are also increased, and people have required the electronic device to be light and thin for portability of the electronic device, so that space reserved for an antenna in the electronic device is more and more limited, and how to improve an antenna structure to have higher antenna efficiency becomes a technical problem to be solved.

### SUMMARY

An antenna assembly is provided in the present disclosure. The antenna assembly includes a first antenna element and a second antenna element. The first antenna element includes a first radiator, a ground branch, and a first signal source. The first radiator includes a first radiating branch and a second radiating branch that are integrally connected to each other, and a joint of the first radiating branch and the second radiating branch is a first feed point. The ground branch has one end electrically connected to the first feed point, and the other end electrically connected to reference ground. The first signal source is electrically connected to the first feed point. The ground branch, the first signal source, and the first radiating branch form a first sub-antenna. The ground branch, the first signal source, and the second radiating branch form a second sub-antenna. The first sub-antenna and the second sub-antenna each are an inverted-F antenna. The first sub-antenna is configured to transmit/receive electromagnetic wave signals of a first target band under excitation of the first signal source. The second sub-antenna is configured to transmit/receive electromagnetic wave signals of a second target band under excitation of the first signal source. The first target band at least partially overlaps with the second target band.

An electronic device is provided in the present disclosure. The electronic device includes a housing and an antenna assembly. At least part of the antenna assembly is disposed in the housing, or at least part of the antenna assembly is disposed out of the housing, or at least part of the antenna assembly is integrated with the housing. The antenna assembly includes a first antenna element and a second antenna element. The first antenna element includes a first radiator, a ground branch, and a first signal source. The first radiator includes a first radiating branch and a second radiating branch that are integrally connected to each other, and a joint of the first radiating branch and the second radiating branch is a first feed point. The ground branch has one end electrically connected to the first feed point, and the other end electrically connected to reference ground. The first signal source is electrically connected to the first feed point. The reference ground includes a first edge and the second edge intersecting the first edge. A connecting point between the first edge and the second edge is a corner portion. The first feed point is disposed close to the corner portion of the reference ground. Under excitation of the first radiating branch and the second radiating branch, a current generated in an extension direction of the second edge is larger than a current generated in an extension of the first edge.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

To describe the technical solutions in embodiments of the present disclosure more clearly, the following briefly introduces the accompanying drawings required for describing embodiments. Apparently, the accompanying drawings in the following description show merely some embodiments of the present disclosure, and those of ordinary skill in the art may still derive other drawings from these accompanying drawings without creative efforts.

FIG. 1 is a schematic structural diagram of an electronic device provided in embodiments of the present disclosure.

FIG. 2 is an exploded schematic structural diagram of the electronic device provided in FIG. 1.

FIG. 3 is a partial schematic structural diagram of the electronic device provided in FIG. 2.

FIG. 4 is a schematic structural diagram of an antenna assembly provided in FIG. 3.

FIG. 5 is a schematic structural diagram of a first antenna element provided in FIG. 4.

FIG. 6 is a schematic structural diagram of a first sub-antenna in FIG. 5.

FIG. 7 is a schematic structural diagram of a second sub-antenna in FIG. 5.

FIG. 8 is a schematic structural diagram of the first antenna element being provided with a switching circuit in FIG. 5.

FIG. 9A is a schematic diagram of the antenna assembly illustrated in FIG. 8 with a first feed point disposed at a first arrangement position.

FIG. 9B is a schematic diagram of the antenna assembly illustrated in FIG. 8 with a first feed point disposed at a second arrangement position.

FIG. 9C is a schematic diagram of the antenna assembly illustrated in FIG. 8 with a first feed point disposed at a third arrangement position.

FIG. 9D is a schematic diagram of the antenna assembly illustrated in FIG. 8 with a first feed point disposed at a fourth arrangement position.

FIG. 9E is a schematic diagram of the antenna assembly illustrated in FIG. 8 with a first feed point disposed at a fifth arrangement position.

FIG. 9F is a schematic diagram of the antenna assembly illustrated in FIG. 8 with a first feed point disposed at a sixth arrangement position.

FIG. 10 is a schematic structural diagram of a first sub-antenna and reference ground illustrated in FIG. 9A.

FIG. 11 is a schematic structural diagram of a second sub-antenna and reference ground illustrated in FIG. 9A.

FIG. 12 is a mode profile of the first sub-antenna illustrated in FIG. 10.

FIG. 13 is a mode profile of the second sub-antenna illustrated in FIG. 11.

FIG. 14 is a current profile of the first sub-antenna illustrated in FIG. 10 in a first radiation mode.

FIG. 15 is a far-field pattern of the first sub-antenna illustrated in FIG. 10 in a first radiation mode.

FIG. 16 is a current profile of the second antenna illustrated in FIG. 11 in a fifth radiation mode.

FIG. 17 is a far-field pattern of the second antenna illustrated in FIG. 11 in a fifth radiation mode.

FIG. 18 is a comparison curve of radiation performance of an antenna assembly provided in embodiments of the present disclosure.

FIG. 19 is a schematic structural diagram of the antenna assembly illustrated in FIG. 4 and reference ground.

FIG. 20 is a graph of S-parameters of the antenna assembly illustrated in FIG. 19.

FIG. 21 is a current profile of the antenna assembly illustrated in FIG. 19 under excitation of a second signal source.

FIG. 22 is a graph of efficiency of the antenna assembly illustrated in FIG. 19.

FIG. 23 is a schematic structural diagram of the antenna assembly illustrated in FIG. 21 and a frame that are mounted in a first manner.

FIG. 24 is a schematic structural diagram of the antenna assembly illustrated in FIG. 21 and a frame that are mounted in a second manner.

### DETAILED DESCRIPTION

The following clearly and completely describes the technical solutions in embodiments of the present disclosure with reference to the accompanying drawings in the embodiments of the present disclosure. Apparently, the described embodiments are merely part rather than all of the embodiments of the present disclosure. In addition, reference herein to “embodiment” or “implementation” means that a particular feature, structure, or characteristic described with reference to the embodiment or the implementation can be included in at least one embodiment of the present disclosure. The appearances of this phrase in various places in the specification are not necessarily all referring to the same embodiment, nor are separate or alternative embodiments mutually exclusive of other embodiments. It is apparent and implicitly understood by those skilled in the art that the embodiments described herein can be combined with other embodiments.

With development of an electronic device such as a smart phone, the electronic device not only serves as a communication device, but also serves as a multimedia device with rich functions (for example, call, video, camera, and the like). With the increase of the number of electronic components in the electronic device and the pursuit of people on portability of the electronic device, the space reserved for an antenna in the electronic device has become smaller and smaller. For example, in 5th generation (5G) mobile communication at present, due to full screen configuration of the electronic device, the clearance space reserved for the antenna is smaller, which greatly affects efficiency of the antenna for receiving an electromagnetic wave and transmitting an electromagnetic wave. At present, a research direction is mainly to reduce an impact of components around the antenna (such as a speaker box, a universal serial bus (USB) data port, a camera, and the like) on the performance of the antenna. However, as the space in the mobile phone reserved for the antenna becomes more and more limited, it is not enough to research this direction alone. Therefore, how to improve an antenna structure and improve antenna efficiency becomes a technical problem to be solved.

For an antenna assembly provided in embodiments of the present disclosure, an antenna structure is improved, and antenna efficiency (the antenna efficiency refers to reception conversion efficiency and transmission conversion efficiency of the antenna assembly for an electromagnetic wave, which will not be described hereinafter) is improved, so that the antenna assembly can be effectively used for a present electronic device with multiple functions and a full screen. The product type of the electronic device for which an antenna assembly is used is not specifically limited in the present disclosure. The electronic device includes, but is not limited to, devices capable of transmitting/receiving electromagnetic wave signals, such as a telephone, a television, a tablet computer, a smart phone, a camera, a personal computer, a notebook computer, an on-board device, an earphone, a watch, a wearable device, a base station, an on-board radar, and a customer premise equipment (CPE). In the present disclosure, for illustrative purpose, the electronic device is a smart phone, and other devices may refer to the detailed description in the present disclosure.

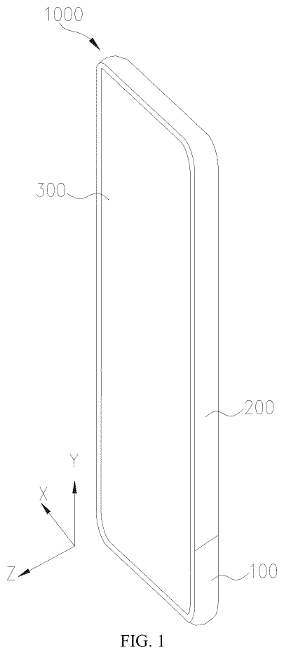

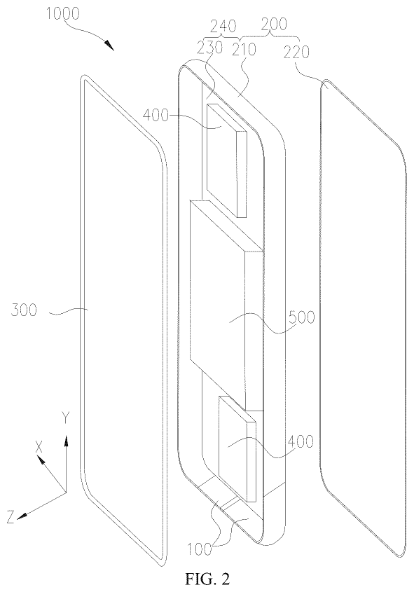

Reference is made to FIG. 1 and FIG. 2, where FIG. 1 is a schematic structural diagram of an electronic device 1000 provided in embodiments of the present disclosure, and FIG. 2 is an exploded schematic structural diagram of the electronic device 1000 in FIG. 1. The electronic device 1000 includes an antenna assembly 100, and a housing 200 and a display screen 300 that cover and are connected to each other. An accommodating space is defined between the display screen 300 and the housing 200, and the antenna assembly 100 is disposed in or out of the accommodating space. The electronic device 1000 further includes a circuit board 400, a battery 500, a camera, a microphone, a telephone receiver, a loudspeaker, a face recognition module, a fingerprint recognition module, and other components that are disposed in the accommodating space and capable of implementing basic functions of the mobile phone, which will not be repeated in the embodiments.

The form of the electronic device 1000 is not limited in the present disclosure. Specifically, the electronic device 1000 may be non-deformable, retractable, bendable, foldable, or the like. Optionally, the antenna assembly 100 is disposed on a retractable assembly of the electronic device 1000. In other words, at least part of the antenna assembly 100 can extend out of the electronic device 1000 along with the retractable assembly of the electronic device 1000, and retract into the electronic device 1000 along with the retractable assembly, so as to increase the clearance space of the radiator and further improve the antenna efficiency when the at least part of the antenna assembly 100 extends out of the electronic device 1000, and to increase the portability of the electronic device 1000 when the at least part of the antenna assembly 100 retracts into the electronic device 1000; or the overall length of the antenna assembly 100 extends along with the extension of the retractable assembly of the electronic device 1000. Optionally, the extension of the length of the antenna assembly 100 includes, but is not limited to, splicing of multiple segments of radiators to form a relatively long length; or the extension of the length of the antenna assembly 100 may also be extension of a distance between the radiator and a radio frequency (RF) chip or other electronic components, so as to increase the clearance space of the antenna assembly 100, thereby further improving the antenna efficiency.

Optionally, the antenna assembly 100 is disposed in the accommodating space of the electronic device 1000, or part of the antenna assembly 100 is integrated with the housing 200, or part of the antenna assembly 100 is disposed out of the housing 200. It can be understood that the electronic device 1000 introduced above is only one description of the electronic device 1000 for which the antenna assembly 100 is used, and a specific structure of the electronic device 1000 should not be understood as a limitation to the antenna assembly 100 provided in the present disclosure.

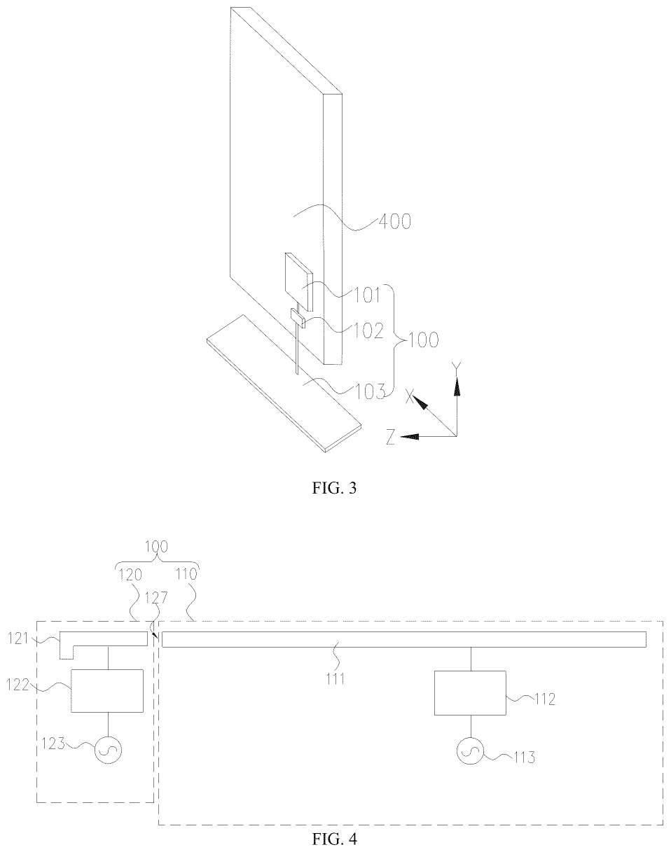

Referring to FIG. 3, the antenna assembly 100 in the present disclosure includes at least a RF transceiver chip 101, a matching module 102, and a radiator 103. The RF transceiver chip 101 may be disposed on the circuit board 400 and electrically connected to the battery 500 or a power management chip, so that the battery 500 supplies power to the RF transceiver chip 101. The matching module 102 may be disposed on the circuit board 400 together with the RF transceiver chip 101, or be disposed on another circuit board 400 together with the radiator 103. The radiator 103 may be disposed on a support in the accommodating space, or disposed on a surface of the housing 200, or integrated with the housing 200. Specific examples will be provided later.

A structure of the antenna assembly 100 provided in the present disclosure will be specifically described in detail below with reference to the accompanying drawings. The antenna assembly 100 provided in the present disclosure includes, but is not limited to, the following embodiments.

Referring to FIG. 4, the antenna assembly 100 includes at least a first antenna element 110. In this embodiment, the antenna assembly 100 includes at least a first antenna element 110 and a second antenna element 120.

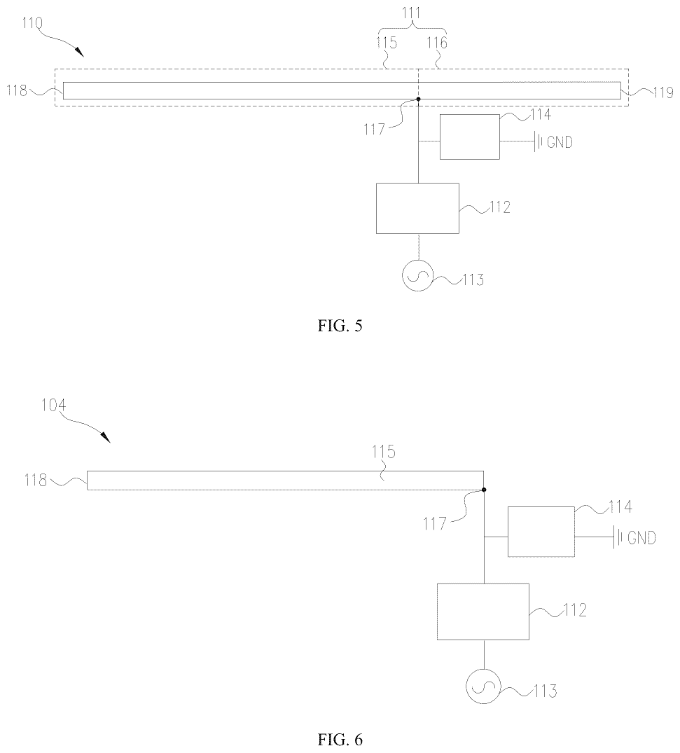

Referring to FIG. 5, the antenna assembly 100 may only include a first antenna element 110. The first antenna element 110 includes at least a first radiator 111, a first signal source 113, and a ground branch 114.

Referring to FIG. 5, the first radiator 111 includes a first radiating branch 115 and a second radiating branch 116 that are integrally connected to each other. A joint between the first radiating branch 115 and the second radiating branch 116 is a first feed point 117.

Referring to FIG. 5, the first radiating branch 115 has a first free end 118 away from the first feed point 117. The second radiating branch 116 has a second free end 119 away from the first feed point 117. In other words, the first radiator 111 has a first free end 118 and a second free end 119 opposite to the first free end 118, and the first feed point 117 disposed between the first free end 118 and the second free end 119. Part of the radiator 103 between the first feed point 117 and the first free end 118 is the first radiating branch 115, and part of the radiator 103 between the first feed point 117 and the second free end 119 is the second radiating branch 116. A specific position of the first feed point 117 on the first radiator 111 is not limited in the present disclosure. In other words, the first radiating branch 115 may have the length equal or unequal to the second radiating branch 116, which is not specifically limited in the present disclosure.

Optionally, the shape of the first radiator 111 is strip-shaped, and an extension direction of the first radiator 111 may be a straight line, a curved line, a bent line, or the like. When the first radiator 111 is in a linear strip shape, the first free end 118 and the second free end 119 are two opposite extremities. When the first radiator 111 is in a bent strip shape, the first free end 118 and the second free end 119 are two extremities in extension directions of the first radiator 111. In other embodiments, the first radiator 111 may also be in the shape of a strip curve, a sheet, a coating, a rod, a film, or the like. The above first radiator 111 may be a line with a uniform width on an extension track, or be in a strip shape with a gradually changing width and a different width such as a widened region.

Referring to FIG. 5, the first signal source 113 is electrically connected to the first feed point 117, and is configured to supply a RF signal (electromagnetic energy) to the first radiator 111 through the first feed point 117.

Optionally, referring to FIG. 5, the first antenna element 110 of the antenna assembly 100 further includes a first matching circuit 112. The first matching circuit 112 has one end electrically connected to the first feed point 117, and the other end electrically connected to the first signal source 113. The first signal source 113 is a RF transceiver chip 101 for transmitting an RF signal (electromagnetic energy), or a feed portion electrically connected to the RF transceiver chip 101 for transmitting the RF signal (electromagnetic energy). The first signal source 113 is configured to feed the electromagnetic energy to the first radiating branch 115 and the second radiating branch 116 through the first matching circuit 112. Optionally, the first matching circuit 112 includes at least one of multiple selection branches formed by switch-capacitor-inductor-resistor, a tuning circuit formed by capacitor-inductor-resistor, or a variable capacitor. The first matching circuit 112 is configured to tune impedance of a feeder (from the first signal source 113 to the first radiator 111), so that conversion efficiency of a RF signal into an electromagnetic wave signal can be improved, and conversion efficiency of an electromagnetic wave signal received into a RF signal can be improved.

Optionally, the ground branch 114 has one end electrically connected to the first feed point 117, and the other end electrically connected to reference ground GND. Optionally, the antenna assembly 100 has the reference ground GND. A specific form of the reference ground GND includes, but is not limited to, a metal plate, a metal layer that is formed in a flexible circuit board 400, etc. When the antenna assembly 100 is disposed in the electronic device 1000, the reference ground GND is a metal alloy plate in a middle frame of the electronic device 1000. The other end of the ground branch 114 is electrically connected to the reference ground GND through a conductive member such as a ground spring sheet, solder, and conductive adhesive. In other embodiments, the antenna assembly 100 does not have any reference ground GND, and the radiator 103 of the antenna assembly 100 is electrically connected to the reference ground GND of the electronic device 1000 directly or through an intermediate conductive connecting member, or electrically connected to the reference ground GND of an electronic component in the electronic device 1000.

Optionally, referring to FIG. 6, the ground branch 114, the first signal source 113, and the first radiating branch 115 form at least part of a first sub-antenna 104. Specifically, the ground branch 114, the first signal source 113, the first radiating branch 115, and the reference ground GND form the first sub-antenna 104.

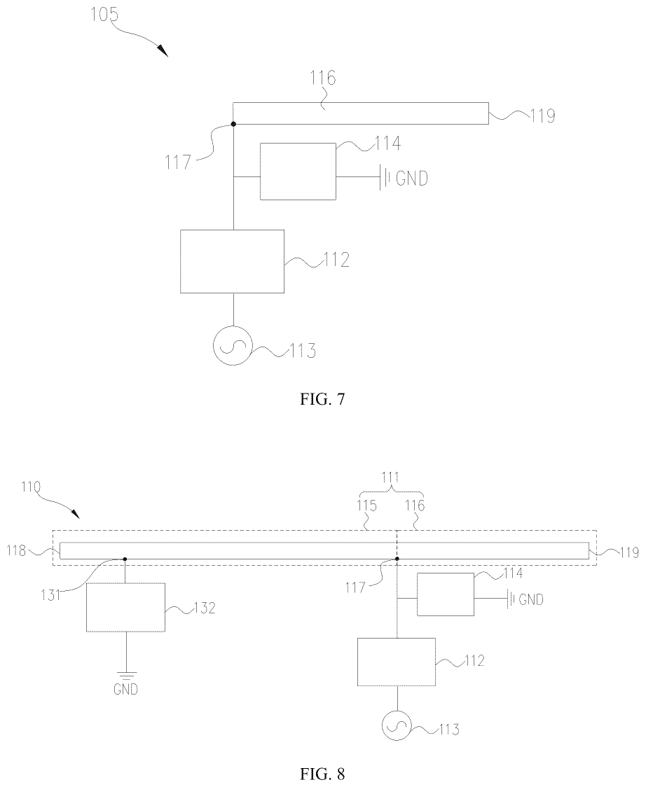

Optionally, referring to FIG. 7, the ground branch 114, the first signal source 113, and the second radiating branch 116 form at least part of a second sub-antenna 105. Specifically, the ground branch 114, the first signal source 113, the second radiating branch 116, and the reference ground GND form the second sub-antenna 105.

Thus, the first antenna element 110 can form the first sub-antenna 104 and the second sub-antenna 105 independent from the first sub-antenna 104. A radiator of the first sub-antenna 104 is different from a radiator of the second sub-antenna 105. Specifically, the radiator of the first sub-antenna 104 is a radiating branch formed by the first radiating branch 115, and the radiator of the second sub-antenna 105 is a radiating branch formed by the second radiating branch 116. The first sub-antenna 104 and the second sub-antenna 105 share the first signal source 113, the ground branch 114, and the reference ground GND.

The first signal source 113 is configured to excite the first radiating branch 115 and the second radiating branch 116 to respectively resonate in a first wavelength mode of a first band. A range of the first band is not specifically limited in the present disclosure. Optionally, the frequency of the first band is less than or equal to 1 GHz. The first wavelength mode includes, but is not limited to, a quarter-wavelength mode, a half-wavelength mode, a three-quarter-wavelength mode, a one-time-wavelength mode, and the like.

Specifically, the first sub-antenna 104 is configured to transmit/receive electromagnetic wave signals of a first target band under excitation of the first signal source 113, and the second sub-antenna 105 is configured to transmit/receive electromagnetic wave signals of a second target band under excitation of the first signal source 113, where the first target band at least partially overlaps with the second target band. It can be understood that in the present disclosure, transmitting/receiving an electromagnetic wave signal of a certain band refers to that an antenna has good efficiency in the band. For example, based on characteristic mode analysis, a mode factor of the first antenna element 110 in the band is greater than or equal to x, and for example, x is 0.9, 0.95, and so on, which indicates that the first antenna element 110 has relatively high antenna efficiency in the band. The above values are only examples, and are not limited thereto.

Optionally, the first target band and the second target band are the same bands, and for example, the first target band and the second target band each is: 600 MHz-1000 MHz (the above values are taken as examples and are not limited), therefore, the first sub-antenna 104 and the second sub-antenna 105 each can transmit/receive electromagnetic wave signals of the first target band (or the second target band). For the first antenna element 110, since the first antenna element 110 can transmit/receive the electromagnetic wave signals of the first target band (or the second target band) through two current paths, radiation efficiency of the first antenna element 110 in the first target band (or the second target band) is improved.

Optionally, the first target band is partially the same as the second target band, and for example, the first target band is 500 MHz-1000 MHz (the above values are taken as examples and are not limited), and the second target band is 600 MHz-1100 MHz (the above values are taken as examples and are not limited). Therefore, the first sub-antenna 104 and the second sub-antenna 105 each can transmit/receive electromagnetic wave signals of 600 MHz-1000 MHz. For the first antenna element 110, since the first antenna element 110 can transmit/receive the electromagnetic wave signals of 600 MHz-1000 MHz through the two current paths, the radiation efficiency of the first antenna element 110 in 600 MHz-1000 MHz is improved.

Regardless of whether the first target band is partially or completely the same as the second target band, in this embodiment, an overlapping band of the first target band and the second target band is defined as the first band. In other words, the first signal source 113 is configured to excite the first radiating branch 115 and the second radiating branch 116 to respectively resonate in a first wavelength mode of the first band. The first sub-antenna 104 and the second sub-antenna 105 each are configured to transmit/receive electromagnetic wave signals of the first band under excitation of the first signal source 113. For the first antenna element 110, since the first antenna element 110 can transmit/receive the electromagnetic wave signals of the first band through the two current paths (i.e., the first sub-antenna 104 and the second sub-antenna 105), the radiation efficiency of the first antenna element 110 in the first band is improved. When the first band is a lower band (LB), the radiation efficiency of the first antenna element 110 resonating in the LB is improved, so that the first antenna element 110 is a low-frequency antenna and has relatively high radiation efficiency.

In the present disclosure, the structure of the antenna assembly 100 is improved. The second radiating branch 116 is formed by extending the first radiating branch 115 at the first feed point 117, and the ground branch 114 is disposed at the first feed point 117. A current distribution is formed between each of the first radiating branch 115, the ground branch 114, and the reference ground GND under the excitation of the first signal source 113, so as to transmit/receive the electromagnetic wave signals covering at least the first band. A current distribution is formed between each of the second radiating branch 116 and the ground branch 114 and the reference ground GND under the excitation of the first signal source 113, so as to transmit/receive the electromagnetic wave signals covering at least the first band. Therefore, the first antenna element 110 can form the first sub-antenna 104 and the second sub-antenna 105, the first sub-antenna 104 and the second sub-antenna 105 generate, under the excitation of the first signal source 113, two current distributions that are independent from each other, each current distribution can excite to generate electromagnetic wave signals covering at least the first band, and electromagnetic wave signals of the first band that are generated under excitation of the two current distributions can improve the efficiency of the first band, so as to improve the radiation efficiency of the first antenna element 110 resonating in the first band.

The range of the first band is not specifically limited in the present disclosure. For example, the first band may be at least one of a LB, a middle high band (MHB), or an ultra-high band (UHB), according to division of transceiving bands. The LB refers to a band with a frequency less than 1000 MHz. The LB includes, but is not limited to, at least one of a global system for mobile communication (GSM) 900 band (GSM 900: 890 MHz-915 MHz; and 935 MHz-960 MHz), GSM 850 band (GSM 850: 824 MHz-849 MHz; and 869 MHz-894 MHz), etc. The MHB refers to a band that is a middle high band. The MHB is 1000 MHz-3000 MHz. The MHB includes, but is not limited to, at least one of a long-term evolution (LTE) band 3 (B3) (1710 MHz-1785 MHz; and 1805-1880 MHz), an LTE band 1 (B1) (1920-1980 MHz; and 2110 MHz-2170 MHz), an LTE band 40 (B40) (2330 MHz-2400 MHz), an LTE band 41 (B41) (2496 MHz-2690 MHz), etc. The UHB is 3000 MHz-6000 MHz. The above are exemplary division methods for the LB, the MHB, and the UHB, but are not limited thereto.

Optionally, referring to FIG. 4, the second antenna element 120 includes a second radiator 121, a second matching circuit 122, a second signal source 123, and a first radiating branch 115. A coupling slot 127 is defined between the second radiator 121 and the first radiating branch 115. The first radiating branch 115 is coupled to the second radiator 121 through the coupling slot 127. The second matching circuit 122 has one end electrically connected to the second radiator 121, and the other end electrically connected to the second signal source 123.

Referring to FIG. 4, the first radiator 111 and the second radiator 121 can be arranged along a straight line or substantially along a straight line (that is, there is a small tolerance in a design process). In other embodiments, the first radiator 111 and the second radiator 121 may also be arranged in a staggered manner in an extension direction, to provide an avoidance space for other components.

Referring to FIG. 4, an end portion of the first radiator 111 faces and is spaced apart from an end portion of the second radiator 121 through the coupling slot 127. Optionally, the coupling slot 127 is a slit between the first radiator 111 and the second radiator 121, and for example, the coupling slot 127 has the width of 0.5 mm-2 mm, but is not limited to this size. The first radiator 111 can be in capacitive coupling with the second radiator 121 through the coupling slot 127. In one of the angles, the first radiator 111 and the second radiator 121 can be considered as two parts formed by the radiator 103 being separated by the coupling slot 127.

The first radiator 111 is in capacitive coupling with the second radiator 121 through the coupling slot 127. The “capacitive coupling” means that, an electric field is generated between the first radiator 111 and the second radiator 121, and a signal of the first radiator 111 can be transferred to the second radiator 121 through the electric field, and a signal of the second radiator 121 can be transferred to the first radiator 111 through the electric field, so that the first radiator 111 and the second radiator 121 can realize electrical signal conduction even in a disconnected state. In this embodiment, the second radiator 121 can generate an electric field under excitation of the second signal source 123, and energy of the electric field can be transferred to the first radiator 111 through the coupling slot 127, so that the first radiator 111 generates an excitation current. In other words, the first radiator 111 may also be referred to as a parasitic radiator of the second radiator 121.

The second signal source 123 is configured to excite the second radiator 121 to resonate in a first wavelength mode of a second band, and excite, through the coupling slot 127, the first radiating branch 115 to resonate in a second wavelength mode of the second band. A range of the second band is not specifically limited in the present disclosure, and optionally, the frequency of the second band is greater than 1 GHz. The first wavelength mode of the second band includes, but is not limited to, a quarter-wavelength mode, a half-wavelength mode, a three-quarter-wavelength mode, a one-time-wavelength mode, and the like. The second wavelength mode of the second band includes, but is not limited to, the quarter-wavelength mode, the half-wavelength mode, the three-quarter-wavelength mode, the one-time-wavelength mode, and the like.

The specific range of the first band and the specific range of the second band are not limited in the present disclosure. Optionally, the first wavelength mode of the second band and the second wavelength mode of the second band are different wavelength modes.

For the antenna assembly 100 and the electronic device 1000 provided in the present disclosure, the ground branch 114 is disposed at the first feed point 117 of the first radiator 111, so that the first antenna element 110 and the reference ground GND form the first sub-antenna 104 and the second sub-antenna 105, the first sub-antenna 104 and the second sub-antenna 105 each can transmit/receive the electromagnetic wave signals of the first band under the excitation of the first signal source 113, and the first radiating branch 115 and the second radiating branch 116 respectively resonate in the first wavelength mode of the first band under the excitation of the first signal source 113. Therefore, efficiency of the first antenna element 110 in the first band is improved, and the radiation efficiency of the antenna assembly 100 is improved. The second radiator 121 resonates in the first wavelength mode of the second band under the action of the second signal source 123, and the first radiator 111 resonates in the second wavelength mode of the second band under excitation of the second signal source 123, the second radiator 121, and the coupling slot 127. Therefore, the first radiator 111 of the first antenna element 110 is also multiplexed as the second radiator 121 of the second antenna element 120, the stacking space of the first radiator 111 of the first antenna element 110 and the second radiator 121 of the second antenna element 120 is saved, and the overall volume of the antenna assembly 100 is reduced. In addition, the antenna assembly 100 can cover more bands or can cover a band with relatively wide width.

When the antenna assembly 100 is disposed in the electronic device 1000, since the electronic device 1000 is provide with the antenna assembly 100, there is no need to additionally dispose a component for improving efficiency, and there is no need to reserve a relatively large clearance space at a periphery of the first radiator 111, so that the antenna efficiency can be effectively improved, the number of components can be reduced, and the space is saved.

Optionally, referring to FIG. 8, the first radiating branch 115 further has a tuning point 131 between the first free end 118 and the first feed point 117, or the second radiating branch 116 further has a tuning point 131 between the second free end 119 and the first feed point 117. The first antenna element 110 of the antenna assembly 100 further includes a switching circuit 132, and the switching circuit 132 has one end electrically connected to the tuning point 131, and the other end electrically connected to the reference ground GND. In other words, the switching circuit 132 is electrically connected to the first radiating branch 115 or the second radiating branch 116. In other embodiments, there are multiple switching circuits 132, and all the multiple switching circuits 132 may be electrically connected to the first radiating branch 115, all the multiple switching circuits 132 may be electrically connected to the second radiating branch 116, or some of the multiple switching circuits 132 may be electrically connected to the first radiating branch 115 and the rest of the multiple switching circuits 132 may be electrically connected to the second radiating branch 116.

Optionally, types of components included in the switching circuit 132 are not limited to an antenna switch, a resistor, a capacitor, an inductor, and the like. A tuning branch can be formed by one antenna switch and at least one of an inductor, a capacitor, a resistor, etc., and the switching circuit 132 includes multiple different tuning branches, so that impedance of the switching circuit 132 can be effectively switched by conducting different tuning branches or selecting different tuning branches to conduct, thereby adjusting impedance of the radiating branch electrically connected to the switching circuit 132, so as to adjust the shift of the resonant frequency of the resonant mode generated by the radiating branch. For example, when the switching circuit 132 is capacitive in the band on which the switching circuit 132 acts, the resonant frequency of the resonant mode affected by the switching circuit 132 moves toward a lower frequency; and when the switching circuit 132 is inductive in the band on which the switching circuit 132 acts, the resonant frequency of the resonant mode affected by the switching circuit 132 moves towards a higher frequency. In addition, for example, when the first radiating branch 115 has relatively high efficiency in the GSM 900 band, by switching switches in the switching circuit 132, an equivalent inductive value of components in the first radiating branch 115 and in the switching circuit 132 is increased, so that the first radiating branch 115 can generate resonance in the GSM 850 band, and the efficiency is relatively high. Therefore, the switching circuit 132 can switch the first radiating branch 115 from covering the GSM 900 band to covering the GSM 850 band, so as to better cover an actual application band. The switching circuit 132 can also switch the GSM 900 band to other bands, which is not repeated herein.

Optionally, the first radiating branch 115 or the second radiating branch 116 is selectively provided or not provided with the switching circuit 132, or the first radiating branch 115 and the second radiating branch 116 each are provided with the switching circuit 132, but two switching circuits 132 are tuned to have different or the same impedance characteristics, so that the first radiating branch 115 and the second radiating branch 116 have relatively high transceiving efficiency in the same band (e.g., adjusting from that the first radiating branch 115 and the second radiating branch 116 each have high transceiving efficiency in the GSM 900 band to that the first radiating branch 115 and the second radiating branch 116 each have relatively high transceiving efficiency in the GSM 850 band), or the first radiating branch 115 and the second radiating branch 116 have relatively high transceiving efficiency in different bands (e.g., adjusting from that the first radiating branch 115 and the second radiating branch 116 each have relatively high transceiving efficiency in the GSM 900 band to that the first radiating branch 115 has relatively high transceiving efficiency in the GSM 900 band and the second radiating branch 116 has relatively high transceiving efficiency in the GSM 850 band). When the first radiating branch 115 and the second radiating branch 116 each generate resonance in the same band, the first antenna element 110 has an efficiency enhancing characteristic in the band; and when the first radiating branch 115 and the second radiating branch 116 generate resonance in different bands, the first antenna element 110 can support more bands at the same time, and has wider application.

Optionally, the antenna assembly 100 further includes a controller, the switching circuit 132 includes multiple switches, and the controller is electrically connected to the multiple switches in the switching circuit 132 to control the multiple switches in the switching circuit 132 to be on or off, so as to tune the impedance of the switching circuit 132, thereby tuning the resonance of the radiating branch electrically connected to the switching circuit 132.

A position of the antenna assembly 100 with respect to the reference ground GND is not specifically limited in the present disclosure.

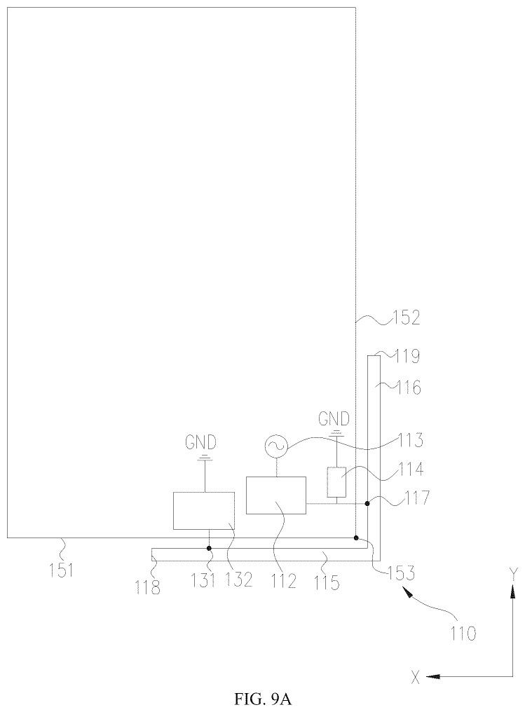

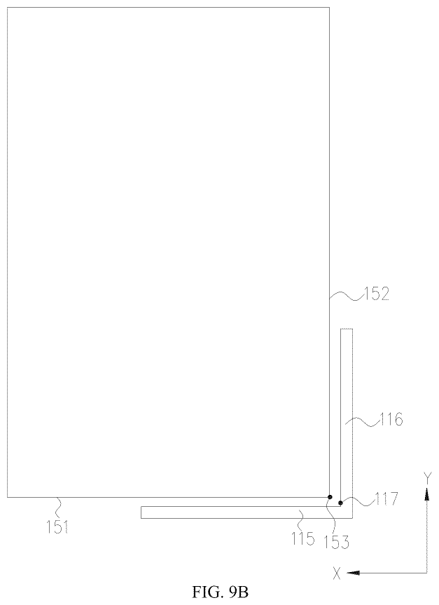

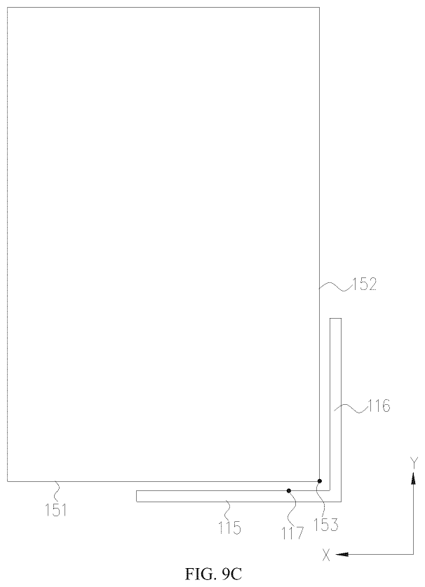

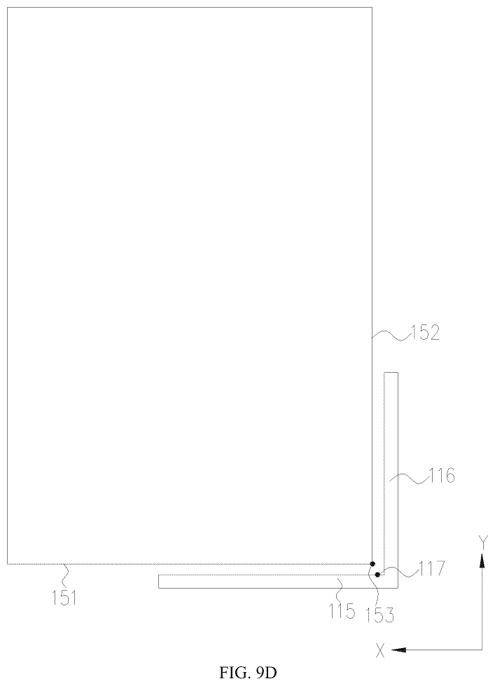

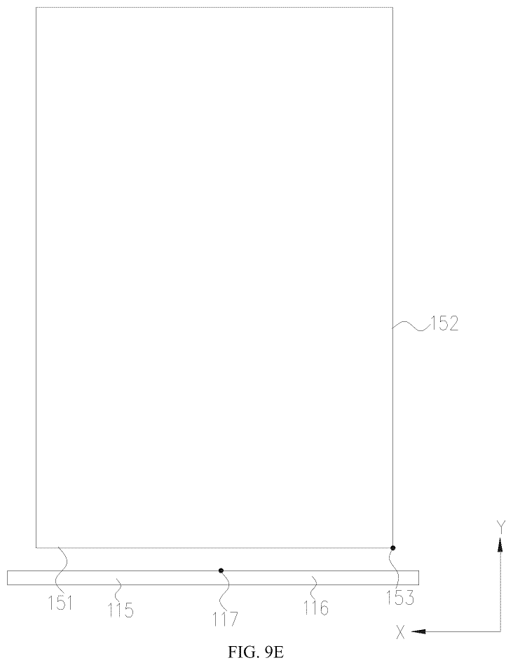

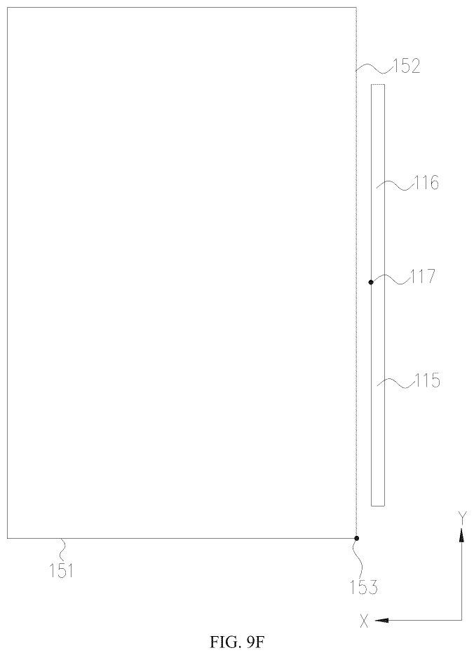

Referring to FIG. 9A, the reference ground GND includes a first edge 151 and a second edge 152 intersecting the first edge 151, and a connecting point between the first edge 151 and the second edge 152 is a corner portion 153. For example, the reference ground GND is substantially rectangular.

Optionally, at least part of the first radiating branch 115 faces and is spaced apart from the first edge 151, and at least part of the second radiating branch 116 faces and is spaced part from the second edge 152. In other words, the first radiator 111 is in an L shape. In this embodiment, the arrangement manner of the first feed point 117 includes, but is not limited to, following cases.

Referring to FIG. 9A, a first arrangement manner of the first feed point 117 is that the first feed point 117 faces the second edge 152.

Referring to FIG. 9B, a second arrangement manner of the first feed point 117 is that first feed point 117 is located at one side of the corner portion 153 away from the second edge 152 in an extension direction of the second edge 152.

Referring to FIG. 9C, a third arrangement manner of the first feed point 117 is that the first feed point 117 faces the first edge 151.

Referring to FIG. 9D, a fourth arrangement manner of the first feed point 117 is that the first feed point 117 is located at one side of the corner portion 153 away from the first edge 151 in an extension direction of the first edge 151.

Optionally, referring to FIG. 9E, all the first radiator 111 faces the first edge 151, and the first feed point 117 faces the first edge 151.

Optionally, referring to FIG. 9F, all the first radiator 111 faces the second edge 152, and the first feed point 117 faces the second edge 152.

For convenience of description, the extension direction of the first edge 151 of the reference ground GND is defined as an X-axis direction, the extension direction of the second edge 152 of the reference ground GND is defined as a Y-axis direction, and a thickness direction of the reference ground GND is defined as a Z-axis direction. A direction of an arrow is a forward direction, and a direction opposite to the arrow is an opposite direction.

Referring to FIG. 9A, optionally, the first feed point 117 is disposed close to the corner portion 153 of the reference ground GND. The first feed point 117 is disposed close to the corner portion 153 of the reference ground GND, more currents in the Y-axis direction (i.e., vertical ground currents) can be generated under excitation of the first radiating branch 115 and the second radiating branch 116, and fewer currents in the X-axis direction (i.e., horizontal ground currents) can be generated under the excitation of the first radiating branch 115 and the second radiating branch 116, so that more longitudinal modes can be excited and fewer transverse modes can be excited, thereby better improving the radiation efficiency. It can be understood that when the first feed point 117 is closer to the corner portion 153 of the reference ground GND, more currents in the Y-axis direction can be generated under the excitation of the first radiator 111, and therefore the resonance current has more longitudinal modes, and the antenna efficiency can be improved better. In other words, under the excitation of the first radiating branch 115 and the second radiating branch 116, a vertical ground current generated on the reference ground GND is larger than a horizontal ground current generated on the reference ground GND.

Specifically, the first feed point 117 is located within ±10 mm of a center, and the center faces the corner portion 153 and is in the extension direction of the first edge 151. This value is only an example, but is not limited thereto.

Specifically, the first feed point 117 is located within ±10 mm of a center, and the center faces the corner portion 153 and is in the extension direction of the second edge 152, and is located in a range of ±10 mm centered on the corner portion 153. This value is only an example, but is not limited thereto.

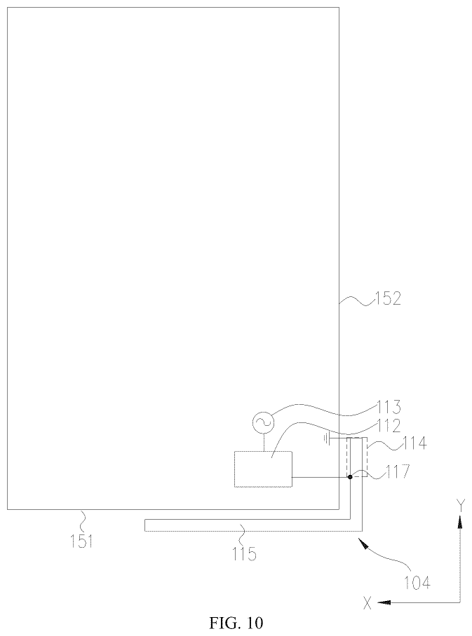

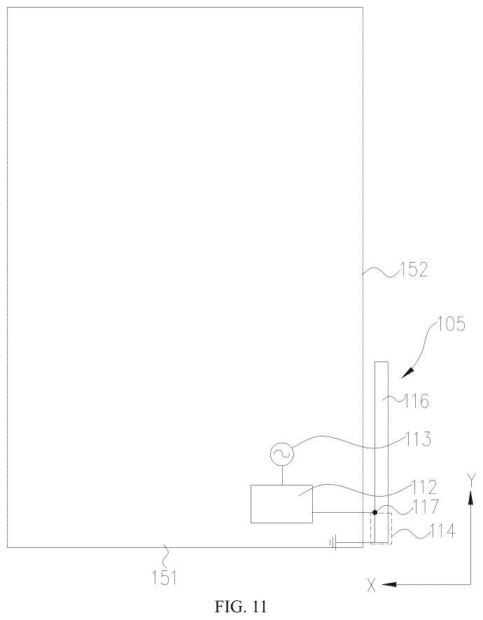

Reference is made to FIG. 10 and FIG. 11, where FIG. 10 is an equivalent structural diagram of the first radiating branch 115 and the ground branch 114, and FIG. 11 is an equivalent structural diagram of the second radiating branch 116 and the ground branch 114. The ground branch 114 is equivalent to a small inductor in the first band. Optionally, the ground branch 114 is equivalent to an inductor with inductance less than or equal to 5 nanohenry (nH) in the first band. The ground branch 114, which is equivalent to the small inductor, forms a path for the current signal of the first band, so that the current signal corresponding to the first band can be grounded through the ground branch 114. Each of the current signal generated on the first radiating branch 115 under the excitation of the first signal source 113 and the current signal generated on the second radiating branch 116 under the excitation of the first signal source 113 can be grounded through the ground branch 114, so that two current paths are formed on the first radiator 111, and in particular, one is grounded from the first radiating branch 115 through the ground branch 114, and the other is grounded from the second radiating branch 116 through the ground branch 114. The above two current paths respectively excite the first radiating branch 115 and the second radiating branch 116 to transmit/receive electromagnetic wave signals covering the first band, so that the first antenna element 110 has the relatively high transceiving efficiency in the first band. Optionally, the first band is less than 1000 MHz. In other words, the first sub-antenna 104 and the second sub-antenna 105 each are configured to transmit/receive the electromagnetic wave signals covering the LB.

Optionally, the first band includes at least one of a GSM 900 band or a GSM 850 band. The GSM 900 band and the GSM 850 band are bands used by global mobile communication systems in different countries. When the first band covers the GSM 900 band, the antenna assembly 100 has relatively high frequency in the GSM 900 band. When the first band covers the GSM 850 band, the antenna assembly 100 has relatively high frequency in the GSM 850 band. When the first band covers both the GSM 900 band and the GSM 850 band, the antenna assembly 100 has relatively high frequency in both the GSM 900 band and the GSM 850 band, which will not be illustrated one by one herein.

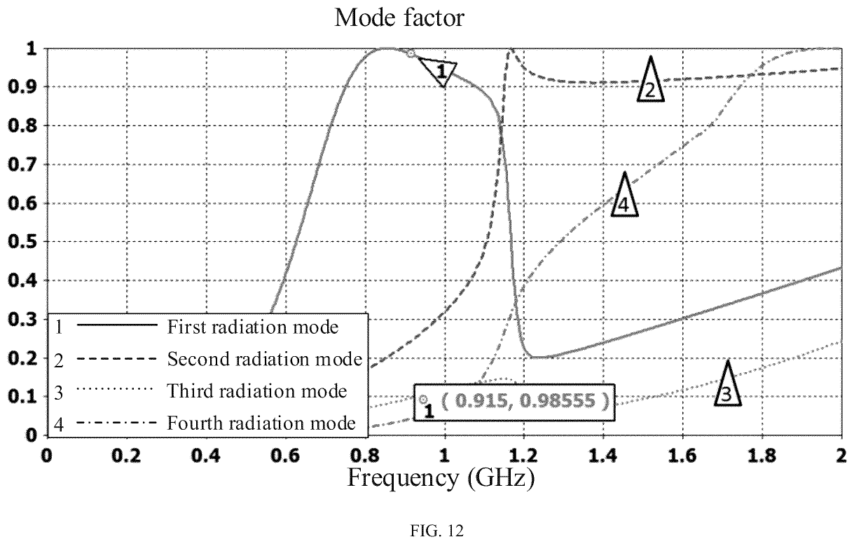

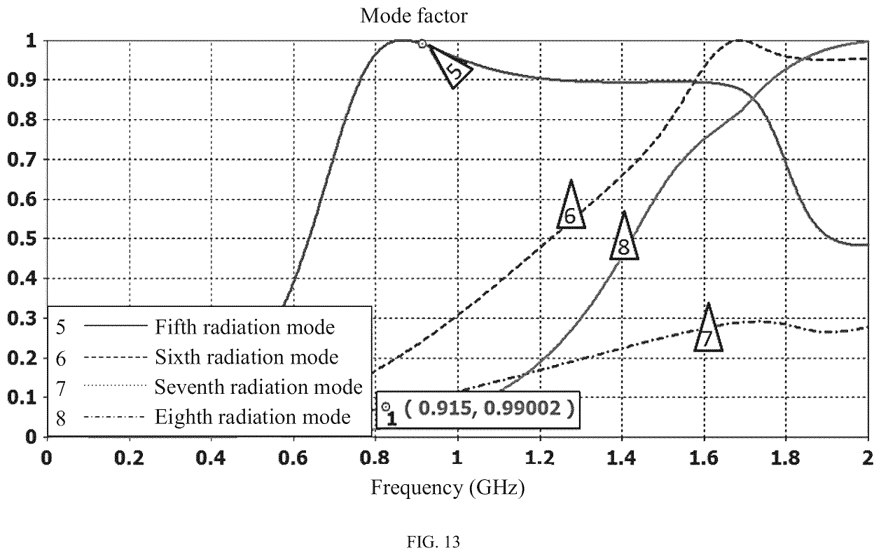

Reference is made to FIG. 12 and FIG. 13, where FIG. 12 is a mode profile of the first sub-antenna 104 illustrated in FIG. 10, and FIG. 13 is a mode profile of the second sub-antenna 105 illustrated in FIG. 11. After characteristic mode analysis is performed on the first sub-antenna 104 illustrated in FIG. 10 and the second sub-antenna 105 illustrated in FIG. 11, it can be seen from FIG. 12 that the first sub-antenna 104 generates four radiation modes, and it can be seen from FIG. 13 that the second sub-antenna 105 also generates four radiation modes. A first radiation mode (corresponding to a curve marked with 1 in FIG. 12) of the first sub-antenna 104 and a fifth radiation mode (corresponding to a curve marked with 5 in FIG. 13) of the second sub-antenna 105 each have a relatively high mode factor (greater than or equal to 0.95) in 0.8 GHz-1 GHz. For example, the mode factor of the first sub-antenna 104 at about 0.915 GHz is and the mode factor of the second sub-antenna 105 at about 0.915 GHz is 0.99. This indicates that a main radiation mode of the first sub-antenna 104 in the GSM 900 band is the first radiation mode and a main radiation mode of the second sub-antenna 105 in the GSM 900 band is the fifth radiation mode. In other words, the first sub-antenna 104 and the second sub-antenna 105 each have relatively high radiation efficiency in the GSM 900 band.

Optionally, the first radiation mode is a first wavelength mode in which the first radiating branch 115 resonates in the first band. The fifth radiation mode is a first wavelength mode in which the second radiating branch 116 resonates in the first band.

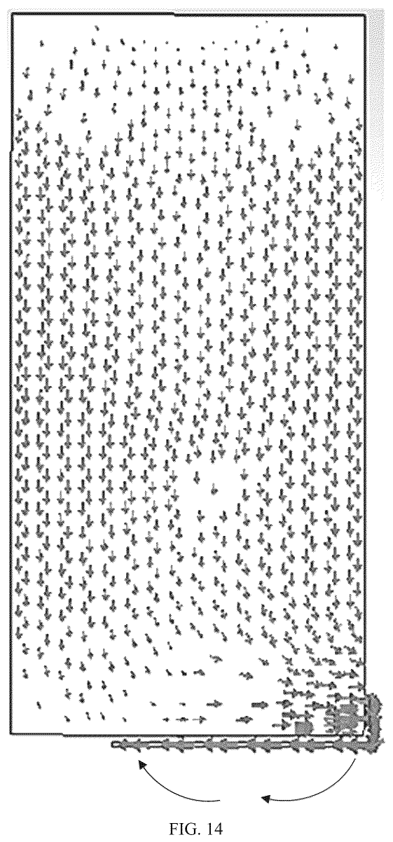

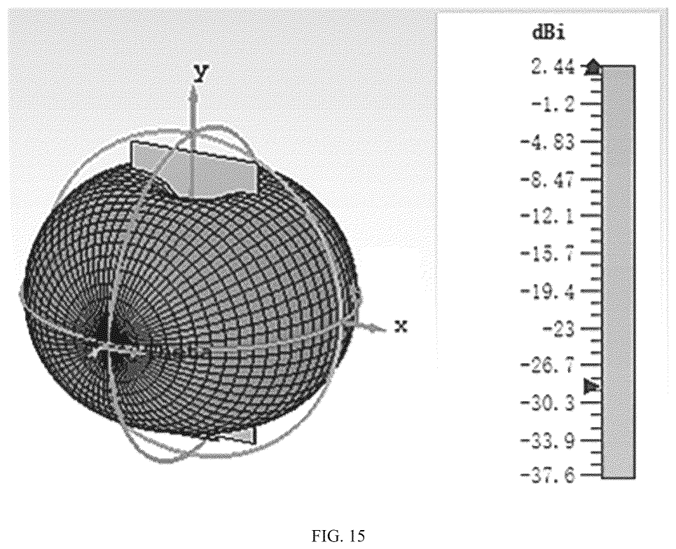

Reference is made to FIG. 14 and FIG. 15, where FIG. 14 is a current profile of the first sub-antenna 104 illustrated in FIG. 10 in the first radiation mode, and FIG. 15 is a far-field pattern of the first sub-antenna 104 illustrated in FIG. 10 in the first radiation mode. When the first sub-antenna 104 resonates in the first band (the first radiation mode), a current is distributed among the reference ground GND, the ground branch 114, the first feed point 117, and the first free end 118. Specifically, the current of the first sub-antenna 104 flows from the reference ground GND to the first free end 118 through the ground branch 114 and the first feed point 117, and the current forms resonance on the first radiating branch 115, so that the first radiation mode illustrated in FIG. 12 is generated. It can be seen from curved arrows in FIG. 14 that the first radiation mode is a half-wavelength mode of the first radiating branch 115 in the first band, and the mode factor in the first radiation mode is relatively high, so that the first radiation mode is the main radiation mode of the first sub-antenna 104 resonating in the first band. In other words, the first wavelength mode of the first radiating branch 115 in the first band is a half-wavelength mode. The first sub-antenna 104 has a relatively high transceiving efficiency in the first band, and it can be seen from FIG. 15 that the first sub-antenna 104 has a relatively high gain in the first band.

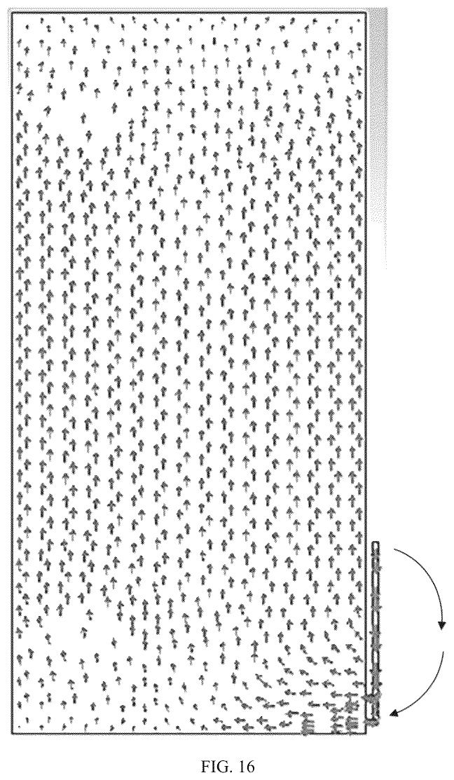

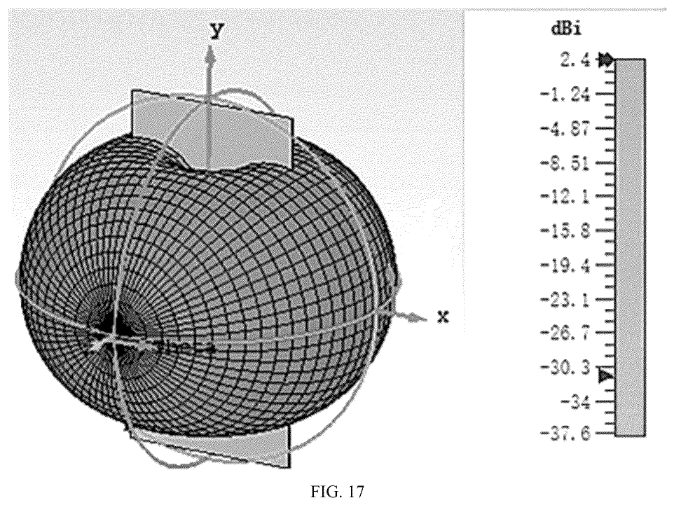

Reference is made to FIG. 16 and FIG. 17, where FIG. 16 is a current profile of the second sub-antenna 105 illustrated in FIG. 11 in the fifth radiation mode, and FIG. 17 is a far-field pattern of the second sub-antenna 105 illustrated in FIG. 11 in the fifth radiation mode. When the second sub-antenna 105 resonates in the fifth radiation mode (that is, in the first band), a current is distributed among the second free end 119, the first feed point 117, the ground branch 114, and the reference ground GND. Specifically, the current of the second sub-antenna 105 flows from the reference ground GND to the second free end 119 through the ground branch 114 and the first feed point 117, and the current forms resonance on the second radiating branch 116, so that the fifth radiation mode is generated. It can be seen from curved arrows in FIG. 16 that the fifth radiation mode is a half-wavelength mode of the second radiating branch 116 in the first band, and the mode factor in the fifth radiation mode is relatively high, so that the fifth radiation mode is the main radiation mode of the second sub-antenna 105 resonating in the first band. In other words, the first wavelength mode of the second radiating branch 116 in the first band is the half-wavelength mode. The second sub-antenna 105 has relatively high transceiving efficiency in the first band. It can be seen from FIG. 15 that the first sub-antenna 104 has a relatively high gain in the first band.

According to the above, by performing a structural design on the antenna assembly 100, the first radiating branch 115 and the second radiating branch 116 each have the relatively high efficiency in the first band. The first radiating branch 115 and the second radiating branch 116 each are part of the first antenna element 110, in other words, two parts of the first antenna element 110 each can have relatively high efficiency in the first band, so that the transceiving efficiency of the first antenna element 110 in the first band is improved.

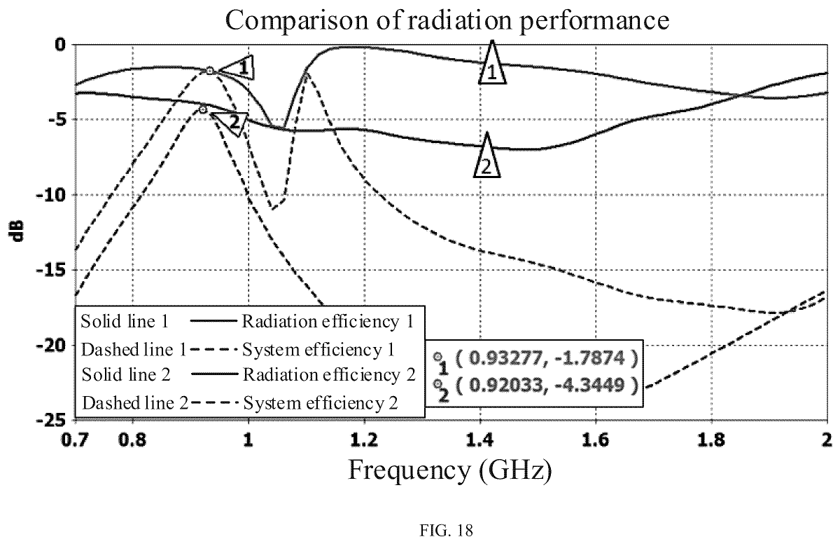

Reference is made to FIG. 18, where FIG. 18 is a comparison curve of radiation performance of an antenna assembly provided in embodiments of the present disclosure. A dashed line 1 in FIG. 18 is a curve of system efficiency 1 of an antenna assembly 100 provided with a first radiating branch 115, a second radiating branch 116, and a ground branch 114. A solid line 1 in FIG. 18 is a curve of the radiation efficiency of the antenna assembly 100 provided with the first radiating branch 115, the second radiating branch 116, and the ground branch 114. A dashed line 2 in FIG. 18 is a curve of system efficiency 2 of the antenna assembly 100 without the second radiating branch 116 and the ground branch 114. A solid line 2 in FIG. 18 is a curve of radiation efficiency 2 of the antenna assembly 100 without the second radiating branch 116 and the ground branch 114. It can be seen from FIG. 18 that the antenna assembly 100 provided with the first radiating branch 115, the second radiating branch 116, and the ground branch 114 can significantly improve the radiation performance of the antenna by using an antenna-efficiency-improvement scheme, and the system efficiency is increased by about 2.5 dB near compared to the system efficiency of the antenna assembly 100 without the second radiating branch 116 and the ground branch 114.

According to a characteristic mode theory, for the antenna assembly 100 provided in the present disclosure, corners of the reference ground GND are fully utilized to excite to generate more longitudinal currents, the first radiating branch 115 and the second radiating branch 116 each form an inverted-F antenna (IFA), and the first radiating branch 115 and the second radiating branch 116 each resonate in the half-wavelength mode of the first band under the excitation of the first signal source 113, so that the radiation performance of the antenna assembly 100 is improved during operation. In other words, the above is the specific structure of the first antenna element 110, and the first antenna element 110 is provided with the first radiating branch 115, the second radiating branch 116, and the ground branch 114, so that the first radiating branch 115 and the second radiating branch 116 resonate in the same mode, thereby increasing the radiation efficiency of the mode.

A specific structure of the second antenna element 120 is illustrated below with reference to the accompanying drawings.

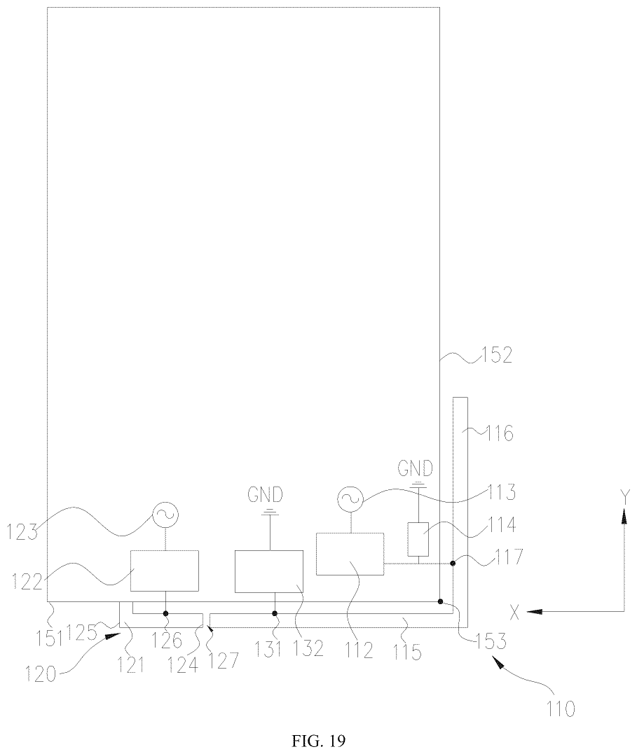

Referring to FIG. 19, the second radiator 121 has a third free end 124, a ground end 125, and a second feed point 126 between the third free end 124 and the ground end 125. The coupling slot 127 is defined between the third free end 124 and an end portion of the first radiator 111. The ground end 125 is electrically connected to reference ground GND. The second matching circuit 122 has one end electrically connected to the second feed point 126, and the other end electrically connected to the second signal source 123.

Specifically, referring to FIG. 19, one end of the second antenna element 120 is the third free end 124, the other end of the second antenna element 120 is the ground end 125, and the second feed point 126 is located between the third free end 124 and the ground end 125, so that the second antenna element 120 is an IFA. The length of the second radiator 121 is about a quarter of a free space wavelength of the operating band of the second antenna element 120, and the second antenna element 120 resonates in a fundamental mode state. The fundamental mode state is also a quarter-wavelength mode of the antenna, and in this case, the reception conversion efficiency or the transmission conversion efficiency of the antenna is relatively high. In other words, the first wavelength mode of the second band is a quarter-wavelength mode of the second band. In addition, as a parasitic branch of the second antenna element 120, the first radiator 111 has the length that is about one time wavelength of the free space wavelength of the operating band of the second antenna element 120. In other words, the second wavelength mode of the second band is a one-time-wavelength mode of the second band.

The coupling slot 127 is defined between the third free end 124 and the end portion of the first radiator 111. Optionally, the coupling slot 127 is defined between the third free end 124 and the first free end 118 of the first radiator 111, and the switching circuit 132 of the first antenna element 110 is electrically connected to the first radiating branch 115; or the coupling slot 127 is defined between the third free end 124 and the second free end 119 of the first radiator 111, and the switching circuit 132 of the first antenna element 110 is electrically connected to the second radiating branch 116. In other words, the second radiator 121 may be disposed at any side of the first radiator 111, and the switching circuit 132 is disposed at one side close to the second radiator 121, so that the switching circuit 132 can tune the operating band of the first antenna element 110 and the operating band of the second antenna element 120.

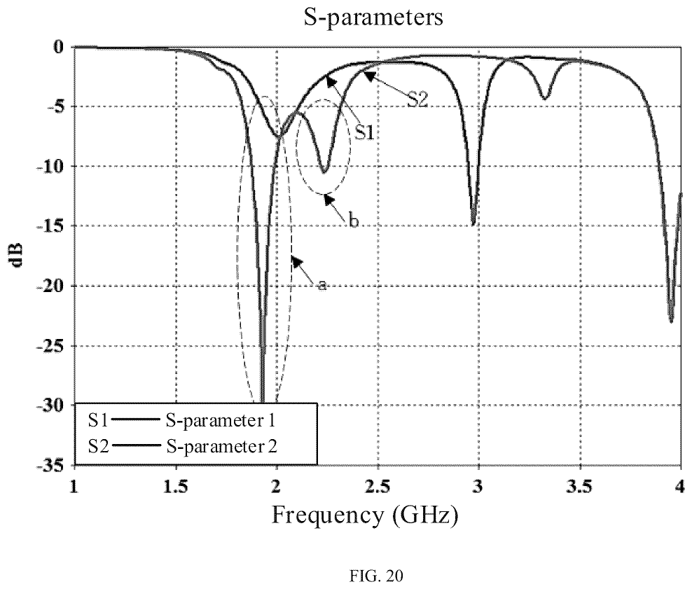

Referring to FIG. 20, the second radiator 121 generates at least one first resonant mode a under excitation of the second signal source 123. Optionally, the first resonant mode a is a first wavelength mode in which the second radiator 121 resonates in the second band. The first radiator 111 generates at least one second resonant mode b under excitation of the second signal source 123. Optionally, the second resonant mode b is a second wavelength mode in which the second radiator 121 resonates in the second band. The resonant mode is characterized by relatively high transmission efficiency of the electromagnetic wave of the antenna assembly 100 at the resonant frequency of the resonant mode. In other words, the second radiator 121 has relatively high transceiving efficiency at a certain resonant frequency, under excitation of the second signal source 123, so that transceiving of the electromagnetic wave signal of a band near the resonant frequency can be supported. Specifically, one resonant mode corresponds to one trough curve in FIG. 20, one resonant mode has one resonant frequency, and the resonant frequency is a frequency corresponding to a trough. One resonant mode has a valid band (that is, a band supported by the resonant mode), that is, for example, formed by corresponding frequencies when an absolute value of a return loss less than or equal to a certain value.

It can be understood that the band supported by the first resonant mode a and the band supported by the second resonant mode b are continuous or discontinuous with each other. The multiple bands being continuous means that two adjacent bands supported by the radiator at least partially overlaps, and the multiple bands being discontinuous means that the two adjacent bands supported by the radiator does not overlaps.

Referring to FIG. 20, in this embodiment, the band supported by the first resonant mode a and the band supported by the second resonant mode b are continuous with each other and form a relatively wide bandwidth, so as to improve data throughput and a data transmission rate of the electronic device 1000 provided with the antenna assembly 100, thereby improving communication quality of the electronic device 1000. In addition, when the bandwidth of the antenna assembly 100 is relatively wide, no tunable component is required to switch different bands, thereby omitting a tunable component, saving costs, and realizing a simple structure of the antenna assembly 100.

For the antenna assembly 100 and the electronic device 1000 provided in the present disclosure, by designing the first radiator 111 and the second radiator 121 to be capacitively coupled, multiple resonant modes are generated, so that the antenna assembly 100 can support a relatively wide bandwidth, thereby improving the throughput and data transmission rate of the electronic device 1000 provided with the antenna assembly 100, and improving the communication quality of the electronic device 1000.

Referring to FIG. 20, when the first radiator 111 is not coupled to the second radiator 121, the second radiator 121 generates one resonance in 1.5 GHz-2.5 GHz under the excitation of the second signal source 123. After the first radiator 111 is coupled to the second radiator 121, the first radiator 111 and the second radiator 121 generate two resonances in 1.5 GHz-2.5 GHz under the excitation of the second signal source 123, where the resonant frequency of the first resonant mode a is about 1.8 GHz, and the resonant frequency of the second resonant mode b is about 2.3 GHz.

By designing that the first radiator 111 of the first antenna element 110 is in capacitive coupling with the second radiator 121 of the second antenna element 120 through the coupling slot 127, the second radiator 121 generates the first resonant mode a under the excitation of the second signal source 123, and the first radiator 111 generates the second resonant mode b under the excitation of the second signal source 123. Therefore, the number of resonant modes is increased, the bandwidth of the band covered by the second antenna element 120 is further increased, and the bandwidth of transmitting/receiving signals by the antenna assembly 100 is increased.

The first radiator 111 of the first antenna element 110 can also be used by the first antenna element 110 to generate a resonant mode, thereby broadening a band of the antenna assembly 100. For an antenna assembly 100 without any coupling, in order to realize the above bandwidth, a longer second radiator 121 needs to be disposed, so that an overall size of the whole antenna assembly 100 is larger, and in the electronic device 1000 with extremely limited space, the antenna assembly 100 with the relatively large size is not conducive to miniaturization of the electronic device 1000.

The first resonant mode a and the second resonant mode b are used to support a second band. The second band is an MHB of 1 GHz-3 GHz. Further, the second band covers 1.85 GHz-2.35 GHz. For example, the band covered by the second band includes, but is not limited to, at least one of the B3, the B1, the B40, or the B41. Optionally, the length of the second radiator 121 is about one quarter of the free space wavelength of the operating band of the second antenna element 120, and the second radiator 121 resonates in a quarter-wavelength mode of the second band under the excitation of the second signal source 123, so that the second radiator 121 has relatively high efficiency. The first wavelength mode of the second band is the quarter-wavelength mode of the second band. The length of the first radiator 111 is about one time of the free space wavelength of the operating band of the second antenna element 120, and the first radiator 111 resonates in a one-time-wavelength mode of the second band under the excitation of the second signal source 123. The second wavelength mode of the second band is the one-time-wavelength mode of the second band.

The antenna assembly 100 provided in the present disclosure utilizes a shared-aperture technology, which utilizes a full-wavelength radiation mode of the radiator of the first antenna element 110 (e.g., a low-frequency antenna), in addition to a quarter-wavelength radiation mode of the own radiator of the second antenna element 120 (e.g., a middle-high-frequency antenna). In a dual radiation mode, performance of the middle-high-frequency antenna is greatly improved compared to a single radiation mode.

In the present disclosure, for the first antenna element 110, two IFAs are integrated and the two IFAs each are enabled to resonate in the first radiation mode, so that the first antenna element 110 has relatively high efficiency in the first radiation mode, and the antenna assembly 100 has relatively high transceiving efficiency in the LB. The switching circuit 32 is disposed on the first radiator 111 to tune the operating band of the first antenna element 110, so that the antenna assembly 100 can effectively cover many bands in the LB, such as the GSM 950 band and the GSM 800 band. The first radiator 111 of the first antenna element 110 is coupled to the second radiator 121 of the second antenna element 120, so that the first radiator 111 can also be used for transmitting/receiving in the second band when being used for transmitting/receiving in the first band, and the second band can cover the MEM, such as the B3, the B1, the B40, and the B41, so as to improve the utilization rate of the first radiator 111. By utilizing the original first radiator 111, the bandwidth of the second band is increased, and an overall size of the radiator 103 of the antenna assembly 100 can also be reduced, thereby reducing the overall size of the antenna assembly 100.

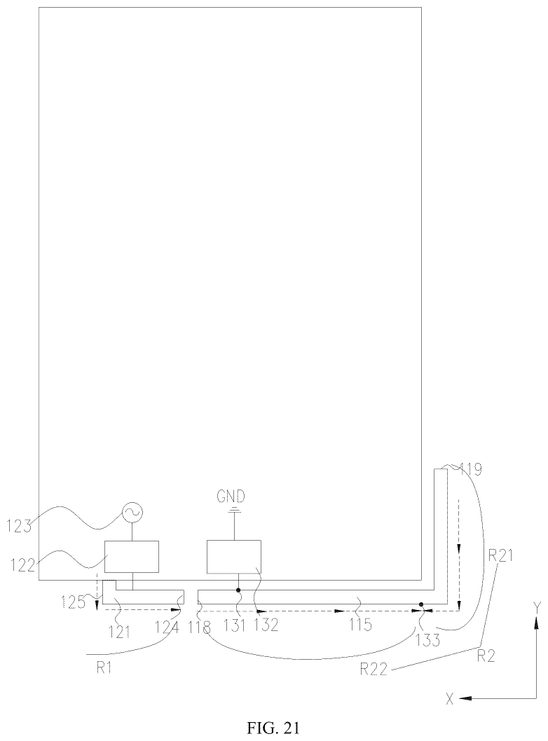

Referring to FIG. 21, a current distribution corresponding to the first resonant mode a includes, but is not limited to, a first current distribution R1: when the second radiator 121 resonates in the second band, a current is distributed between the ground end 125 and the third free end 124. The first current distribution R1 specifically includes, but is not limited to, that the current flows from the ground end 125 to the third free end 124. The above current distribution generates the first resonant mode a, that is, the first current distribution on the second radiator 121 corresponds to the quarter-wavelength mode of the second radiator 121 in the second band.

Referring to FIG. 21, a current distribution corresponding to the second resonant mode b includes, but is not limited to, a second current distribution R2: when the first radiator 111 resonates in the second band, a current includes a first sub-current R21 and a second sub-current R22. The first radiator 111 further has an intersection 133, and the intersection 133 is located between the first free end 118 and the first feed point 117, or between the second free end 119 and the first feed point 117, or at the first feed point 117; and the first sub-current R21 is distributed between the second free end 119 and the intersection 133, the second sub-current R22 is distributed between the first free end 118 and the intersection 133, and the first sub-current R21 has a flow direction opposite to the second sub-current R22. The second current distribution R2 specifically includes, but is not limited to, that the first sub-current R21 flows from the second free end 119 to the intersection 133, and the second sub-current R22 flows from the first free end 118 to the intersection 133. The intersection 133 includes, but is not limited to, a middle position of the first radiator 111 in an extension-length direction. The above current distribution generates the second resonant mode b, that is, the second current distribution of the first radiator 111 corresponds to the one-time-wavelength mode of the first radiator 111 in the second band.

The current distribution of the second antenna element 120 in the second band is illustrated in FIG. 21, with arrows representing flow directions of currents and arcs representing range distributions of the currents. It can be seen that on the second radiator 121, the current is distributed according to a quarter wavelength, and on the first radiator 111, the current is distributed according to a one-time wavelength.

For example, the second antenna element 120 of the antenna assembly 100 resonates in an LTE B1 state. FIG. 20 shows a comparison between a reflection coefficient of the second antenna element 120 including the second radiator 121 alone and a reflection coefficient of the second antenna element 120 including the second radiator 121 and the first radiating branch 115, and it can be found that the second antenna element 120 including the second radiator 121 and the first radiating branch 115 has a better impedance matching characteristic, and the reflection coefficient is less than −5 dB in 1.85 GHz-2.35 GHz. In this embodiment, an absolute value of a return loss curve greater than or equal to 5 dB is taken as a reference value with relatively high transceiving efficiency of the electromagnetic wave. In other embodiments, the reference value may also be 6 dB, 7 dB, and so on. In other words, the second band covers 1.85 GHz-2.35 GHz. For example, the band covered by the second band includes, but is not limited to, at least one of the B3, the B1, the B40, or the B41.

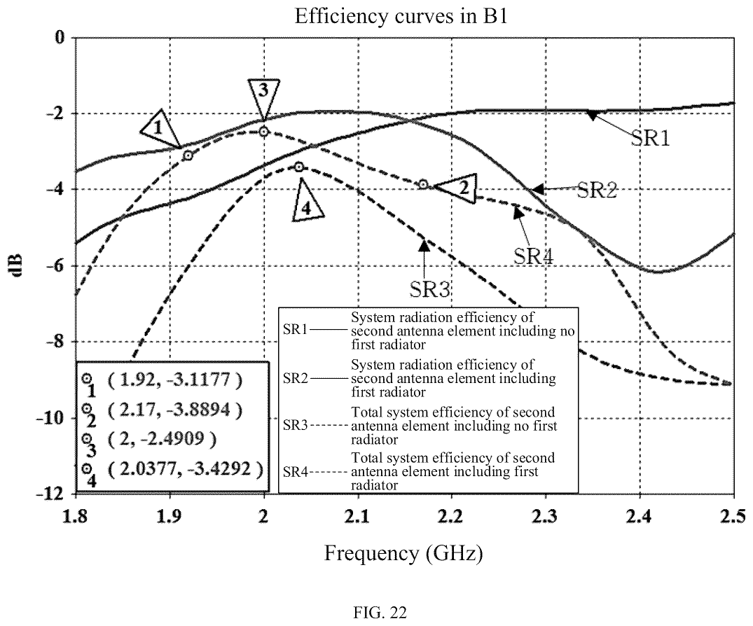

FIG. 22 illustrates a comparison between radiation performance of the second antenna element 120 including the second radiator 121 alone and radiation performance of the second antenna element 120 including the second radiator 121 and the first radiating branch 115, and it can be found that when the second antenna element 120 resonates in B1, the second antenna element 120 including the second radiator 121 and the first radiating branch 115 has a higher radiation frequency and wider radiation bandwidth, and has peak efficiency 1 dB higher than the efficiency of the second antenna element 120 including the second radiator 121 alone. In B1, a mean value of system efficiency of the second antenna element 120 including the second radiator 121 and the first radiating branch 115 is −3 dB, and a radiation characteristic is excellent.

In a general technology, an effective efficiency bandwidth of an antenna is not wide enough, for example, the effective efficiency bandwidth is difficult to cover B3 and B40 at the same time, which causes that switches need to be additionally disposed, resulting in poor signal of the antenna in coverage of certain bands or insufficient miniaturization of the antenna. It should be noted that the above bands are merely exemplary, and cannot be taken as a limitation to the bands that can be radiated in the present disclosure.

For the antenna assembly 100 provided in the present disclosure, by designing the first radiator 111 to be coupled to the second radiator 121, the structure of the antenna assembly 100 is miniaturized and multiple resonant modes are generated, and the multiple resonant modes can cover the second band at the same time (e.g., the second band includes 1.85 GHz-2.35 GHz), so that the antenna assembly 100 can support a relatively wide bandwidth, thereby improving the throughput and the data transmission rate of the electronic device 1000 provided with the antenna assembly 100. When the antenna assembly 100 is for the above MHB (e.g., 1710 MHz-2690 MHz), B3 and B40 can be supported at the same time. Therefore, the antenna assembly 100 is simple and miniaturized in structure at least, and has relatively high efficiency and data transmission rate in an application band of B3 and B40.

The bands listed above may be MHBs used by multiple operators, and the antenna assembly 100 provided in the present disclosure may simultaneously support any one or any combination of the multiple bands mentioned above, so that the antenna assembly 100 provided in the present disclosure can support models of the electronic device 1000 corresponding to multiple different operators, and there is no need to adopt different antenna structures for different operators, thereby further improving an application scope of the antenna assembly 100 and compatibility of the antenna assembly 100.

Based on the characteristic mode and shared-aperture technology, the present disclosure designs the first antenna element 110 (e.g., the low-frequency antenna) and the second antenna element 120 (e.g., the medium-high-frequency antenna) both with excellent performance, and proposes a set of high-performance terminal antenna solutions. In this set of solutions, the radiation performance of the first antenna element 110 (e.g., the low-frequency antenna) is greatly improved without increasing additional space and clearance. On the basis of utilizing radiating branches of the second antenna element 120 (e.g., the medium-high-frequency antenna), the second antenna element 120 utilizes high-order mode of a metal branch of the first antenna element 110 (for example, a low-frequency antenna) in a shared-aperture manner, and common radiation is formed in the medium-high frequency, thereby greatly improving the radiation performance of the medium-high-frequency antenna.

The specific position where the radiator 103 of the antenna assembly 100 is disposed on the electronic device 1000 is not specifically limited in the present disclosure. The antenna assembly 100 is disposed in the housing 200; or at least part of the antenna assembly 100 is integrated with the housing 200. Specifically, examples are illustrated by the following embodiments.

Referring to FIG. 2, the housing 200 includes an edge frame 210 and a rear cover 220. A middle plate 230 is formed in the edge frame 210 through injection, and multiple mounting grooves for mounting various electronic components are defined on the middle plate 230. The reference ground GND can be located on the middle plate 230. The middle plate 230, together with the edge frame 210, forms the middle frame 240 of the electronic device 1000. After the display screen 300, the middle frame 240, and the rear cover 220 are closed, an accommodating space is defined on each side of the middle frame 240.

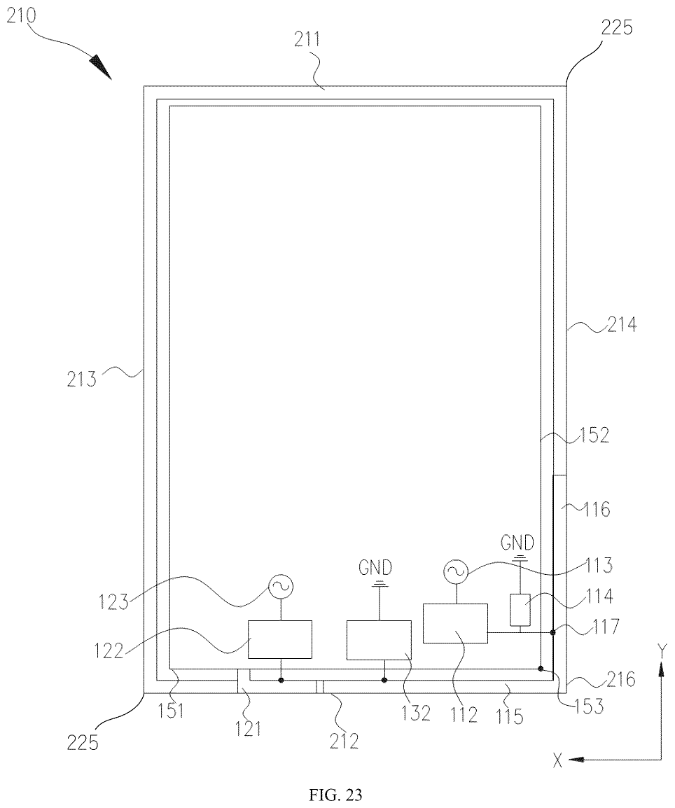

Referring to FIG. 2 and FIG. 23, the edge frame 210 has one side that surrounds and is connected to the periphery of the rear cover 220, and the other side that surrounds and is connected to the periphery of the display screen 300. The edge frame 210 includes multiple side edge-frames connected end to end. Among the multiple side edge-frames of the edge frame 210, two adjacent side edge-frames intersect. For example, the two adjacent side edge-frames are perpendicular to each other. The multiple side frames include a top edge-frame 211 and a bottom edge-frame 212 opposite to the top edge-frame 211, and a first side-edge-frame 213 and a second side-edge-frame 214 that each are connected between the top edge-frame 211 and the bottom edge-frame 212. A joint between two adjacent side edge-frames is a corner 225. The top edge-frame 211 is parallel to and equal to the bottom edge-frame 212. The first side-edge-frame 213 is parallel to and equal to the second side-edge-frame 214. The first side-edge-frame 213 has the length greater than the top edge-frame 211.

The arrangement of the antenna assembly 100 is not specifically limited in the present disclosure.

Optionally, referring to FIG. 23, the first radiator 111 of the antenna assembly 100 is disposed at the bottom edge-frame 212, the second side-edge-frame 214, and the corner 225 between the bottom edge-frame 212 and the second side-edge-frame 214. The first radiating branch 115 is disposed at the bottom edge-frame 212 close to the second side-edge-frame 214, the second radiating branch 116 is disposed at the second side-edge-frame 214 close to the bottom edge-frame 212, and the second radiator 121 is disposed at the bottom edge-frame 212 or at the second side-edge-frame 214.

The first radiator 111 may also be disposed at the top edge-frame 211, the second side-edge-frame 214, and the corner 225 between the top edge-frame 211 and the second side-edge-frame 214. The second radiator 121 may be disposed at the top edge-frame 211 or the second side-edge-frame 214. The first radiator 111 may also be disposed at other corners 225, which are not listed one by one herein.

The first radiator 111 is disposed at the corner 225 of the edge frame 210, and the corner 225 of the edge frame 210 corresponds to the corner portion 153 of the reference ground GND, so that the first radiating branch 115 of the first radiator 111 forms an electric field with one edge of the reference ground GND and the second radiating branch 116 of the first radiator 111 forms an electric field with one edge of the reference ground GND, and the first radiating branch 115 and the second radiating branch 116 each can form an IFA with the same construction. Therefore, the first radiating branch 115 and the second radiating branch 116 generate the same radiation mode in the first band, to support transmission/reception of the signal of the first band, thereby improving the transceiving efficiency strengthened of the antenna assembly 100 in the first band can be improved.

Optionally, referring to FIG. 23, at least part of the radiator 103 of the antenna assembly 100 is integrated with the edge frame 210. For example, the edge frame 210 is made of metal. The first radiator 111, the second radiator 121, and the edge frame 210 are integrated into one body. In other embodiments, the above radiator 103 may also be integrated with the rear cover 220. In other words, the first radiator 111 and the second radiator 121 are integrated as part of the housing 200. Specifically, the antenna assembly 100 includes the reference ground GND, the first signal source 113, the second signal source 123, the matching circuit, and the switching circuit 132 that are all disposed on the flexible circuit board 400.

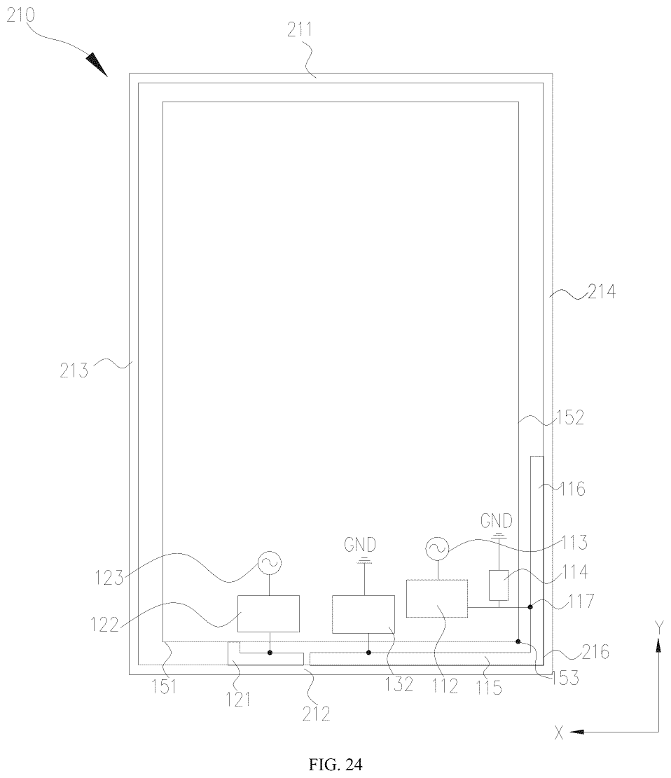

Optionally, referring to FIG. 24, the first radiator 111 and the second radiator 121 are formed on the surface of the edge frame 210. Specifically, the basic forms of the first radiator 111 and the second radiator 121 include, but are not limited to, a patch radiator 103, or being formed on the inner surface of the edge frame 210 through processes such as laser direct structuring (LDS) or print direct structuring (PDS). In this embodiment, the edge frame 210 may be made of a non-conductive material. The above radiator 103 may also be disposed on the rear cover 220.

Optionally, the first radiator 111 and the second radiator 121 are disposed on the flexible printed circuit board 400. The flexible printed circuit board 400 is attached to a surface of the edge frame 210. The first radiator 111 and the second radiator 121 can be integrated on the flexible printed circuit board 400, and the flexible printed circuit board 400 is attached to the inner surface of the middle frame 240 by an adhesive or the like. In this embodiment, the edge frame 210 may be made of a non-conductive material. The radiator 103 may also be disposed on the inner surface of the rear cover 220.

The above are only some embodiments of the present disclosure. It should be noted that, those ordinary skilled in the art may make further improvements and modifications without departing from the principle of the present disclosure, and these improvements and modifications shall also belong to the scope of protection of the present disclosure.

What is claimed is:

1. An antenna assembly comprising:
a first antenna element, wherein the first antenna element comprises a first radiator, a ground branch, and a first signal source; the first radiator comprises a first radiating branch and a second radiating branch that are integrally connected to each other, and a joint of the first radiating branch and the second radiating branch is a first feed point; the ground branch has one end electrically connected to the first feed point, and the other end electrically connected to reference ground, and the first signal source is electrically connected to the first feed point;
wherein the ground branch, the first signal source, and the first radiating branch form a first sub-antenna, the ground branch, the first signal source, and the second radiating branch form a second sub-antenna, the first sub-antenna and the second sub-antenna each are an inverted-F antenna, the first sub-antenna is configured to transmit/receive electromagnetic wave signals of a first target band under excitation of the first signal source, and the second sub-antenna is configured to transmit/receive electromagnetic wave signals of a second target band under excitation of the first signal source, wherein the first target band at least partially overlaps with the second target band.

2. The antenna assembly of claim 1, further comprising a second antenna element, wherein the second antenna element comprises a second radiator, a second signal source, and the first radiating branch, a coupling slot is defined between the second radiator and the first radiating branch, the first signal source is configured to excite the first radiating branch and the second radiating branch to respectively resonate in a first wavelength mode of a first band, the second signal source is electrically connected to the second radiator, and the second signal source is configured to excite the second radiator to resonate in a first wavelength mode of a second band, and excite, through the coupling slot, the first radiating branch to resonate in a second wavelength mode of the second band.

3. The antenna assembly of claim 2, wherein the first wavelength mode of the first band is a half-wavelength mode.

4. The antenna assembly of claim 2, wherein the first wavelength mode of the second band is a quarter-wavelength mode of the second band, and the second wavelength mode of the second band is a one-time-wavelength mode of the second band.

5. The antenna assembly of claim 2, wherein the first band has a frequency less than or equal to 1 gigahertz (GHz), and the second band has a frequency greater than 1 GHz.

6. The antenna assembly of claim 1, wherein the ground branch is equivalent to an inductor with inductance less than or equal to 5 nanohenry (nH) in the first band.

7. The antenna assembly of claim 2, wherein the first radiating branch has a first free end away from the first feed point, and the second radiating branch has a second free end away from the first feed point; and the antenna assembly further comprises the reference ground, and the first free end and the second free end each are spaced apart from the reference ground.

8. The antenna assembly of claim 7, wherein:
the first radiating branch further has a tuning point located between the first free end and the first feed point, or the second radiating branch further has a tuning point located between the second free end and the first feed point; and
the antenna assembly further comprises a switching circuit, and the switching circuit has one end electrically connected to the tuning point, and the other end electrically connected to the reference ground.

9. The antenna assembly of claim 7, wherein the reference ground comprises a first edge and a second edge intersecting the first edge, a connecting point between the first edge and the second edge is a corner portion, at least part of the first radiating branch faces the first edge, and at least part of the second radiating branch faces the second edge.

10. The antenna assembly of claim 9, wherein the first feed point faces the first edge, or the first feed point is located at one side of the corner portion away from the first edge in an extension direction of the first edge.

11. The antenna assembly of claim 9, wherein the first feed point faces the second edge, or the first feed point is located at one side of the corner portion away from the second edge in an extension direction of the second edge.

12. The antenna assembly of claim 9, wherein the first radiator faces the first edge, or the first radiator faces the second edge.

13. The antenna assembly of claim 7, wherein when the first radiating branch resonates in the first wavelength mode of the first band, a current is distributed among the reference ground, the ground branch, the first feed point, and the first free end; and/or, when the second radiating branch resonates in the first wavelength mode of the first band, a current is distributed among the second free end, the first feed point, the ground branch, and the reference ground.

14. The antenna assembly of claim 1, further comprising a first matching circuit, wherein the first matching circuit has one end electrically connected to the first feed point, and the other end electrically connected to the first signal source.

15. The antenna assembly of claim 2, wherein the second antenna element further comprises a second matching circuit, the second radiator has a third free end, a ground end, and a second feed point between the third free end and the ground end, the coupling slot is defined between the third free end and an end portion of the first radiator, and the ground end is electrically connected to the reference ground; and the second matching circuit has one end electrically connected to the second feed point, and the other end electrically connected to the second signal source.

16. The antenna assembly of claim 15, wherein:
the coupling slot is defined between the third free end and a first free end of the first radiator, and the first antenna element comprises a switching circuit electrically connected to the first radiating branch; or the coupling slot is defined between the third free end and a second free end of the first radiator, and the first antenna element comprises the switching circuit electrically connected to the second radiating branch; and
the first free end of the first radiator and the second free end of the first radiator are two opposite ends.

17. The antenna assembly of claim 16, wherein when the second radiator resonates in the first wavelength mode of the second band, a current is distributed between the ground end and the third free end; and
when the first radiator resonates in the second wavelength mode of the second band, a current comprises a first sub-current and a second sub-current, the first radiator further has an intersection, and the intersection is located between the first free end and the first feed point, or between the second free end and the first feed point, or at the first feed point; and the first sub-current is distributed between the second free end and the intersection, the second sub-current is distributed between the first free end and the intersection, and the first sub-current has a flow direction opposite to the second sub-current.

18. The antenna assembly of claim 1, wherein under excitation of the first radiating branch and the second radiating branch, a vertical ground current generated on the reference ground is larger than a horizontal ground current generated on the reference ground.

19. An electronic device, comprising:
a housing and an antenna assembly, wherein at least part of the antenna assembly is disposed in the housing, or at least part of the antenna assembly is disposed out of the housing, or at least part of the antenna assembly is integrated with the housing;
wherein the antenna assembly comprises a first antenna element, wherein the first antenna element comprises a first radiator, a ground branch, and a first signal source; the first radiator comprises a first radiating branch and a second radiating branch that are integrally connected to each other, and a joint of the first radiating branch and the second radiating branch is a first feed point; the ground branch has one end electrically connected to the first feed point, and the other end electrically connected to reference ground, and the first signal source is electrically connected to the first feed point;
wherein under excitation of the first radiating branch and the second radiating branch, a vertical ground current generated on the reference ground is larger than a horizontal ground current generated on the reference ground.

20. The electronic device of claim 19, wherein the antenna assembly further comprises a second antenna element, wherein the second antenna element comprises a second radiator, a second signal source, and the first radiating branch, a coupling slot is defined between the second radiator and the first radiating branch, the first signal source is configured to excite the first radiating branch and the second radiating branch to respectively resonate in a first wavelength mode of a first band, the second signal source is electrically connected to the second radiator, and the second signal source is configured to excite the second radiator to resonate in a first wavelength mode of a second band, and excite, through the coupling slot, the first radiating branch to resonate in a second wavelength mode of the second band.
